(19) United States
(12) Patent Application Publication
(10) Pub. No.: US 2012/0098872 A1
(43) Pub. Date: Apr. 26, 2012

(54) METHOD OF DRIVING ELECTROPHORETIC DISPLAY PANEL

(75) Inventors: Jong-Hee KIM, Hwaseong-si (KR); Cheol-Woo PARK, Suwon-si (KR); Uk-Chul CHOI, Cheonan-si (KR); Hyun-Sik HWANG, Ansan-si (KR); Kyoung-Ho LIM, Pyeongtaek-si (KR)

(73) Assignee: SAMSUNG ELECTRONICS CO., LTD., Suwon-si (KR)

(21) Appl. No.: 13/181,991

(22) Filed: Jul. 13, 2011

(30) Foreign Application Priority Data
Oct. 26, 2010 (KR) 2010-0104441

(51) Int. Cl. G09G 5/10

(52) U.S. Cl. 345/690; 345/107

(57) ABSTRACT

A method of driving an electrophoretic display panel includes: applying a first voltage having a first polarity with respect to a reference voltage to an electrophoretic display panel to display an N-th image, where N is a natural number; applying the first voltage to the electrophoretic display panel, on which the N-th image is displayed, to display a first full-grayscale image; applying a second voltage having a second polarity with respect to a reference voltage to an electrophoretic display panel, on which the first full-grayscale image is displayed, to display a second full-grayscale image, where the second polarity is opposite to the first polarity; and applying the first polarity voltage to the electrophoretic display panel, on which the second full grayscale image is displayed, to display an (N+1)-th image.

This application claims priority to Korean Patent Application No. 2010-104441, filed on Oct. 26, 2010, and all the benefits accruing therefrom under 35 U.S.C. §119, the content of which in its entirety is herein incorporated by reference.

### BACKGROUND OF THE INVENTION

(1) Field of the Invention

Exemplary embodiments of the present invention relate to a method of driving an electrophoretic display panel. More particularly, exemplary embodiments of the present invention relate to a method of driving an electrophoretic display panel with enhanced display quality.

(2) Description of the Related Art

Generally, an electrophoretic display apparatus includes electrically charged particles and displays data by altering positions of the electrically charged particles using an electric field.

The electrophoretic display apparatus typically includes a cathode, an anode and a microcapsule having a ball shape disposed between the cathode and the anode. The microcapsule includes a white particle charged with a negative charge and a black particle charged with a positive charge. The white and black particles may have bi-stable characteristics. For example, the white and black particles may move when the electric field is generated, and stop moving when the electric field is blocked. Thus, the electrophoretic display apparatus displays the previous image as it is without a power source, such that the electrophoretic display apparatus may have low power consumption and high usability.

However, a direct current (“DC”) charge is accumulated on the particles having the bi-stable characteristics, such that a durability of the electrophoretic display apparatus may decrease and an afterimage may occur. Thus, the particles moved by previously displayed data may be compensated before present data are displayed.

### BRIEF SUMMARY OF THE INVENTION

Exemplary embodiments of the present invention provide a method of driving an electrophoretic display panel with reduced power consumption and enhanced display quality.

In an exemplary embodiment, a method of driving an electrophoretic display panel includes: applying a first voltage having a first polarity with respect to a reference voltage to an electrophoretic display panel to display an N-th image, where N is a natural number; applying the first voltage to the electrophoretic display panel, on which the N-th image is displayed, to display a first full-grayscale image; applying a second voltage having a second polarity with respect to a reference voltage to an electrophoretic display panel, on which the first full-grayscale image is displayed, to display a second full-grayscale image, where the second polarity is opposite to the first polarity; and applying the first polarity voltage to the electrophoretic display panel, on which the second full grayscale image is displayed, to display an (N+1)-th image.

In an exemplary embodiment, a method of driving an electrophoretic display panel includes: applying a first voltage having a first polarity with respect to a reference voltage to the electrophoretic display panel to display an N-th image, where N is a natural number; applying. The first voltage to the electrophoretic display panel, on which the N-th image is displayed, to display a first full-grayscale image; applying a second voltage having a second polarity with respect to the reference voltage to the electrophoretic display panel, on which the first full-grayscale image is displayed, to display an (N+1)-th image, where the second polarity is opposite to the first polarity; and applying the second polarity voltage to the electrophoretic display panel, on which the (N+1)-th image is displayed, to display a second full-grayscale image.

In an exemplary embodiment, a method of driving an electrophoretic display panel includes: displaying an N-th image on the electrophoretic display panel, where N is a natural number; converting a middle grayscale of the N-th to a black grayscale; converting each of a black grayscale of the N-th image and the black grayscale converted from the middle grayscale of the N-th image to a white grayscale; and displaying an (N+1)-th image on the electrophoretic display panel having a full white grayscale.

In an exemplary embodiment, a positive charge or a negative charge is applied to the electrophoretic particles that are charged to display a previous image, such that the previous image is substantially rapidly converted to at least one of a full black image and a full white image. Therefore, power consumption during an image transition is substantially decreased, and flash occurring at the image transition is substantially decreased.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a block diagram illustrating an exemplary embodiment of an electrophoretic display apparatus according to the present invention;

FIG. 2 is a cross-sectional view of an exemplary embodiment of an electrophoretic display panel in FIG. 1;

FIG. 3 is a conceptual diagram illustrating an exemplary embodiment of a method of driving the electrophoretic display panel in FIG. 1;

FIG. 4 is a conceptual diagram illustrating an alternative exemplary embodiment of the method of driving an electrophoretic display panel according to the present invention;

FIG. 5 is a conceptual diagram illustrating an alternative exemplary embodiment of the method of driving an electrophoretic display panel according to the present invention;

FIG. 6 is a conceptual diagram illustrating an alternative exemplary embodiment of the method of driving an electrophoretic display panel according to the present invention;

FIG. 7 is a conceptual diagram illustrating an alternative exemplary embodiment of the method of driving an electrophoretic display panel according to the present invention;

FIG. 8 is a conceptual diagram illustrating an alternative exemplary embodiment of the method of driving an electrophoretic display panel according to the present invention; and

FIG. 9 is a conceptual diagram illustrating an alternative exemplary embodiment of the method of driving an electrophoretic display panel according to the present invention.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the present invention will be described in further detail with reference to the accompanying drawings.

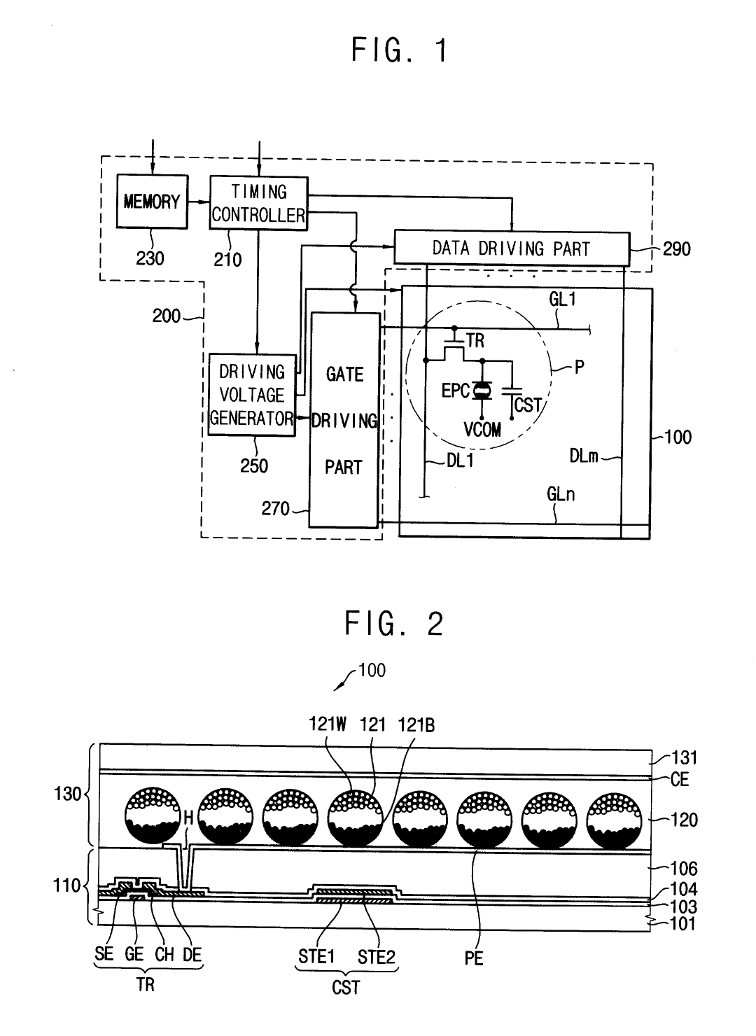

FIG. 1 is a block diagram illustrating an exemplary embodiment of an electrophoretic display apparatus according to the present invention. FIG. 2 is a cross-sectional view of an exemplary embodiment of an electrophoretic display panel in FIG. 1.

Referring to FIGS. 1 and 2, the electrophoretic display apparatus includes an electrophoretic display panel 100, and a driving part 200 that drives the electrophoretic display panel 100.

The electrophoretic display panel 100 includes a plurality of pixels P. Each of the pixels P includes a switching transistor TR connected to a gate line GL and a data line DL, an electrophoretic capacitor EPC connected to the switching transistor TR, and a storage capacitor CST connected to the switching transistor TR. In an exemplary embodiment, the electrophoretic display panel 100 includes an array substrate 110 and an electrophoretic film 130, as shown in FIG. 2.

The array substrate 110 includes a first base substrate 101. A plurality of gate lines GL1 to GLn extending in a first direction, a plurality of data lines DL1 to DLn extending in a second direction crossing the first direction, a plurality of switching transistor TR electrically connected to the gate lines GL1 to GLn and the data lines DL1 to DLn, respectively, and pixel electrodes PE and storage capacitors CST electrically connected to the switching transistors TR are disposed on the first base substrate 101.

The switching transistor TR includes a gate electrode GE connected to a corresponding gate line, e.g., the first gate line GL1, a gate insulation layer 103 disposed on the gate electrode GE, a channel portion CH disposed on the gate insulating layer 103 overlapping the gate electrode GE, and source and drain electrodes SE and DE disposed spaced apart from each other on the channel portion CH. The source electrode SE is connected to the data line DL. A protection layer 104 and an organic layer 106 are disposed on the switching transistor TR. A pixel electrode PE, which is electrically connected to the drain electrode DE through a contact hole H formed through the protection layer 104 and the organic layer 106, is disposed on the organic layer 106.

The storage capacitor CST includes a first storage electrode STE1 electrically connected to a storage common line, the gate insulation layer 103 disposed on the first storage electrode STE1, and a second storage electrode STE2 electrically connected to the pixel electrode PE and disposed on the gate insulating layer 103. The first and second storage electrodes STE1 and STE2 overlap each other.

The electrophoretic film 130 includes a second base substrate 131, a common electrode CE and an electrophoretic layer 120. The second base substrate 131 may include a material having flexibility. In an exemplary embodiment, the second base substrate 131 may include a polyethylene terephthalate (“PET”) having high light permeability, high heat resistance, high chemical resistance, high mechanical strength.

The common electrode CE includes a transparent conductive material and disposed opposite to the pixel electrode PE, and receives a common voltage VCOM, which is a reference voltage. The transparent conductive material may include, for example, an indium tin oxide (“ITO”), an indium zinc oxide (“IZO”) or an amorphous indium tin oxide (“a-ITO”), but not being limited thereto.

The electrophoretic layer 120 includes a plurality of microcapsules 121. Each of the microcapsules 121 includes particles charged with a positive (+) charge and a negative (−) charge. In an exemplary embodiment, the microcapsule 121 includes a white particle 121W charged with a negative (−) charge and a black particle 121B charged with a positive (+) charge. An exemplary embodiment of a method of driving an electrophoretic layer 120 will now be described in detail.

When a first voltage having a first polarity with respect to the common voltage VCOM, e.g., a positive voltage, is applied to the pixel electrode PE, the white particle 121W charged with a negative (−) charge drifts toward the pixel electrode PE and the black particle 121B charged with a positive (+) charge drifts toward the common electrode CE. Accordingly, a black image is displayed on the electrophoretic display panel 100. When a second voltage having a second polarity with respect to the common voltage VCOM, e.g., a negative voltage, is applied to the pixel electrode PE, the black particle 121B charged with a positive (+) charge drifts toward the pixel electrode PE and the white particle 121W charged with a negative (−) charge drifts toward the common electrode CE. Accordingly, a white image is displayed on the electrophoretic display panel 100. When the common voltage VCOM is applied to the pixel electrode PE, the white particle and the black particle 121W and 121B may stop moving and the positions thereof are maintained, that is, the image displayed on the electrophoretic display panel 100 is maintained.

The driving part 200 includes a timing controller 210, a memory 230, a driving voltage generator 250, a gate driving part 270 and a data driving part 290.

The timing controller 210 generally controls the driving part 200 based on an external control signal including a horizontally synchronized signal and a vertically synchronized signal which are received from an external source.

The memory 230 stores data received from the external source, as a data unit of a single image.

The driving voltage generator 250 generates a driving voltage. The driving voltage includes a gate voltage provided to the gate driving part 270, a data voltage provided to the data driving part 290, and a common voltage VCOM provided to the electrophoretic display panel 100. The gate voltage includes a gate-on voltage and a gate-off voltage to generate the gate signal. In an exemplary embodiment, the data voltage may include the first voltage (e.g., the positive voltage), a common voltage VCOM and the second voltage (e.g., the negative voltage). In an alternative exemplary embodiment, the data voltage may be a supply voltage to generate the first voltage (e.g., the positive voltage) and the second voltage (e.g., the negative voltage).

The gate driving part 270 generates the gate signal using the gate voltage in accordance with the control of the timing controller 210. The gate driving part 270 sequentially outputs the gate signal to the gate lines GL1 to GLn.

The data driving part 290 outputs the first voltage (e.g., the positive voltage), the common voltage VCOM and the second voltage (e.g., the negative voltage) to the data lines DL1 to DLn in accordance with the control of the timing controller 210.

In an exemplary embodiment, when the electrophoretic display panel 100 displays a 16-grayscale image, the common voltage VCOM is applied to the common electrode CE of the electrophoretic capacitor EPC included in the pixel P, and the positive voltage of about +1 V, the common voltage of about 0 V, or the negative voltage of about −1 V is applied to the pixel electrode PE according to the grayscale. When a 15-grayscale image is displayed, the data voltage of about 0 V substantially the same as the common voltage of about 0 V is applied to the pixel electrode PE. When a 14-grayscale image is displayed, the data voltage of about +1 V is applied to the pixel electrode PE during one frame. When a 13-grayscale image is displayed, the data voltage of about +1 V is applied to the pixel electrode PE during two frames. When displaying a 12-grayscale, the data voltage of about +1 V is applied to the pixel electrode PE during three frames. When a 0-grayscale image is displayed as the same manner as the above, the data voltage of about +1 V is applied to the pixel electrode PE during fifteen frames.

When the 0-grayscale image is converted to a 7-grayscale image, the negative data voltage, for example, about −1 V, is applied to the pixel electrode PE during seven frames. When the 0-grayscale image is converted to the 15-grayscale image as the same manner, the data voltage of about −1 V is applied to the pixel electrode PE during fifteen frames.

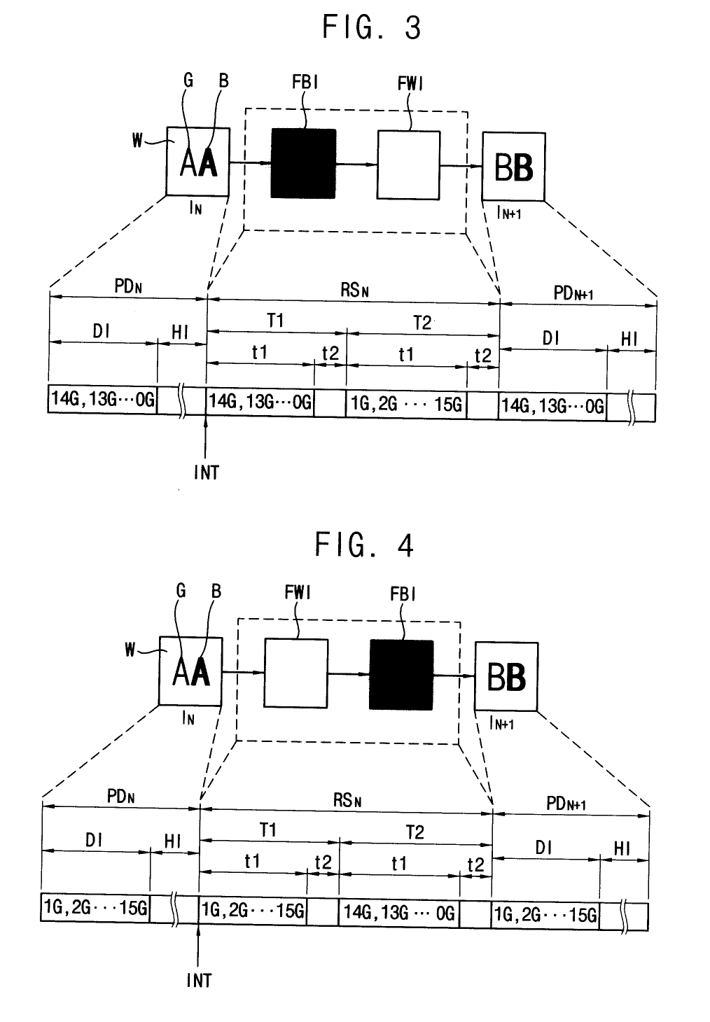

FIG. 3 is a conceptual diagram illustrating an exemplary embodiment of a method of driving the electrophoretic display panel in FIG. 1.

Referring to FIGS. 1 and 3, a driving interval of the electrophoretic display panel 100 includes an N-th image interval PD_{N}, an N-th full reset interval RS_{N}, and an (N+1)-th image interval PD_{N+1}. Here, ‘N’ is a natural number. Each of the N-th image interval PD_{N} and the (N+1)-th image interval PD_{N+1} includes a display interval DI, in which the images are displayed on the electrophoretic display panel 100, and a maintenance interval HI, in which the displayed images are maintained.

In an exemplary embodiment, the driving part 200 applies the positive data voltage to the electrophoretic display panel 100 during the display interval DI of the N-th image interval PD_{N} and displays the N-th image I_{N} including a plurality of grayscales, e.g., a 0-grayscale B, a 6-grayscale G and a 15-grayscale W.

In one exemplary embodiment, for example, the driving part 200 may apply the data voltage of about 0 V to first pixels that display the 15-grayscale W. The driving part 200 may apply the data voltage of about +1 V to second pixels that display the 0-grayscale B during fifteen frames. Accordingly, the second pixels are charged by a voltage corresponding to about +15 V. The driving part 200 may apply the data voltage of about +1 V to third pixels that display the 6-grayscale G during nine frames, and then apply the data voltage of about 0 V during six frames. Accordingly, the third pixels are charged by a voltage corresponding to about +6 V. The driving part 200 consumes at least fifteen frames to display the N-th image I_{N}.

Then, until an interrupt signal NT, which may be a transition image signal generated based on a user's operation, for example, is received, the driving part 200 maintains the N-th image I_{N} displayed on the electrophoretic display panel 100. The maintenance interval HI may be defined as an interval between an ending point of the display interval DI of the N-th image interval PD_{N} and a starting point of the interrupt signal INT. The driving part 200 applies the common voltage of about 0 V to the entire pixels of the electrophoretic display panel 100 as the data voltage during the maintenance interval HI, and then blocks the data voltage. Accordingly, the electrophoretic display panel 100 maintains the N-th image I_{N}.

When the interrupt signal NT is generated to display the (N+1)-th image I_{N+1}, the driving part 200 compensates differences among the negative charges and the positive charges, which are charged to the electrophoretic particles to display the N-th image I_{N}, during the N-th full reset interval RS_{N}. The N-th full reset interval RS_{N} includes a first interval T1 and a second interval T2. The driving part 200 displays a full black image FBI on the electrophoretic display panel 100 during the first interval T1, and displays a full white image FWI on the electrophoretic display panel 100 during the second interval T2.

In an exemplary embodiment of a method of displaying the full black image FBI on the electrophoretic display panel 100, the positive data voltage is applied to the electrophoretic display panel 100 on which the N-th image I_{N} is displayed, and the full black image FBI is thereby displayed on the electrophoretic display panel 100. Until the highest grayscale of the grayscales of the N-th image I_{N} is converted to the black grayscale (e.g., 0-grayscale), the positive data voltage is applied to the electrophoretic display panel 100 on which the N-th image I_{N} is displayed.

In one exemplary embodiment, for example, the driving part 200 may apply the data voltage of about +1 V to the first pixels, which display the 15-grayscale W for the N-th image I_{N}, during the fifteen frames, apply the data voltage of about 0 V to the second pixels, which display the 0-grayscale B for the N-th image I_{N}, and apply the data voltage of about +1 V to the third pixels, which display the 6-grayscale G for the N-th image I_{N}, during the six frames. Accordingly, the entire pixels of the electrophoretic display panel 100 are charged by a voltage corresponding to about +15 V. Then, the driving part 200 continuously applies the data voltage of about +1 V to the entire pixels during the number of preset frames, e.g., the second frame t2, and displays the full black image FBI on the electrophoretic display panel 100.

The first interval T1 may have intervals corresponding to the number of frames including the number of the first frame t1, during which the full black image FBI on the electrophoretic display panel 100 is displayed after the N-th image I_{N} is displayed, and the number of the preset second frame t2. In an exemplary embodiment, the first interval T1 may have intervals corresponding to a total of twenty frames including fifteen frames for the first frame t1, during which the 15-grayscale of the highest grayscale of the N-th image I_{N} is converted to the 0-grayscale of the black grayscale, and five frames for the preset second frame t2.

As shown in FIG. 3, after the full black image FBI is displayed on the electrophoretic display panel 100, the driving part 200 displays a full white image FWI on the electrophoretic display panel 100.

In an exemplary embodiment of a method of displaying the full white image FWI, the negative data voltage about −1 V is applied to the entire pixels of the electrophoretic display panel 100, on which the full black image FBI is displayed, during the second interval T2 having a time period substantially the same as the time period of the first interval T1. The second interval T2 may have intervals corresponding to a total of twenty frames including the fifteen frames for the first frame t1, during which the 0-grayscale of the black grayscale is converted to the 15-grayscale of the highest grayscale, and the five frames for the preset second frame t2. Accordingly, the entire pixels of the electrophoretic display panel 100 are charged by a voltage corresponding to about 0 V. Thus, the entire pixels of the electrophoretic display panel 100 may compensate a difference of the charge charged for the N-th image I_{N} during the N-th full reset interval RS_{N}.

After the N-th full reset interval RS_{N}, the driving part 200 displays the (N+1)-th image I_{N+1} on the electrophoretic display panel 100 during the (N+1)-th image interval PD_{N+1}. The (N+1)-th image interval PD_{N+1} may include the display interval DI and the maintenance interval HI.

In an example embodiment, an additional positive charge is applied to the electrophoretic particles charged to display a previous image, such that the previous image is substantially rapidly converted to the full black image Accordingly, power consumption during an image transition is substantially decreased.

FIG. 4 is a conceptual diagram illustrating an alternative exemplary embodiment of the method of driving an electrophoretic display panel according to the present invention.

Hereinafter, the same or like elements shown in FIG. 4 have been labeled with the same reference characters as used above to describe the exemplary embodiment shown in FIG. 3, and any repetitive detailed description thereof will be omitted or simplified.

Referring to FIGS. 1 and 4, the driving interval of the electrophoretic display panel 100 includes the N-th image interval PD_{N}, the N-th full reset interval RS_{N}, and the (N+1)-th image interval PD_{N+1}. Here, ‘N’ is a natural number.

The driving part 200 applies the negative data voltage to the electrophoretic display panel 100 during the display interval DI of the N-th image interval PD_{N} and displays the N-th image I_{N} including a plurality of grayscales, e.g., the 0-grayscale B, the 15-grayscale W and the 6-grayscale G

When the interrupt signal NT is generated, the driving part 200 compensates differences among the charges of the electrophoretic particles, which is charged to display the N-th image I_{N}, during the N-th full reset interval RS_{N}. The N-th full reset interval RS_{N} includes a first interval T1 and a second interval T2, and the driving part 200 displays a full white image FWI on the electrophoretic display panel 100 during the first interval T1 and displays a full black image FBI on the electrophoretic display panel 100 during the second interval T2.

In an exemplary embodiment of a method of displaying the full white image FWI on the electrophoretic display panel 100, the negative data voltage is applied to the electrophoretic display panel 100, on which the N-th image I_{N} is displayed, to display the full white image FWI on the electrophoretic display panel 100. Until the lowest grayscale of the grayscales of the N-th image I_{N} is converted to the white grayscale (15-grayscale), the negative data voltage is applied to the electrophoretic display panel 100, on which the N-th image I_{N} is displayed.

In one exemplary embodiment, for example, the driving part 200 may apply the data voltage of about −1 V to the second pixels, which display the 0-grayscale B for the N-th image I_{N}, during the fifteen frames, apply the data voltage of about 0 V to the first pixels, which display the 15-grayscale W for the N-th image I_{N}, to maintain the 15-grayscale, and apply the data voltage of about −1 V to the third pixels, which display the 6-grayscale G for the N-th image I_{N}, during the nine frames. Accordingly, the entire pixels of the electrophoretic display panel 100 are charged by a voltage corresponding to the data voltage of about 0 V. Then, the driving part 200 continuously applies the data voltage of about −1 V to the entire pixels during five frames corresponding to the preset second frame t2, and displays the full white image FWI on the electrophoretic display panel 100.

The first interval T1 may have intervals corresponding to a total of twenty frames including the fifteen frames for the first frame t1, during which the 0-grayscale of the lowest grayscale of the N-th image I_{N} is converted to the 15-grayscale of the white grayscale, and the five frames for the preset second frame t2.

In an exemplary embodiment, after the full white image FWI is displayed on the electrophoretic display panel 100, the driving part 200 displays a full black image FBI on the electrophoretic display panel 100.

In an exemplary embodiment of a method of displaying the full black image FBI, the positive data voltage is applied to the entire pixels of the electrophoretic display panel 100, on which the full white image FWI is displayed, during the second interval T2 having a time period substantially the same as a time period of the first interval T1. The second interval T2 may have intervals corresponding to a total of twenty frames including the fifteen frames for the first frame t1, during which the 15-grayscale of the white grayscale is converted to the 0-grayscale of the black grayscale, and the five frames for the preset second frame t2. Accordingly, the entire pixels of the electrophoretic display panel 100 are charged by a voltage corresponding to about +15 V. Thus, the electrophoretic display panel 100 displays the full black image FBI.

The entire pixels of the electrophoretic display panel 100 may compensate the differences among the charges of the electrophoretic particles, which are charged to display the N-th image I_{N}, during the N-th full reset interval RS_{N}.

After the N-th full reset interval RS_{N}, the driving part 200 displays the (N+1)-th image I_{N+1} on the electrophoretic display panel 100 during the (N+1)-th image interval PD_{N+1}.

The (N+1)-th image interval PD_{N+1} includes the display interval DI and the maintenance interval HI.

In an exemplary embodiment, during the display interval DI of the (N+1)-th image interval PD_{N+1}, the driving part 200 applies the negative data voltage and displays the (N+1)-th image I_{N+1} including the 0-grayscale B, the 15-grayscale W and the 6-grayscale G, for example, on the electrophoretic display panel 100.

In one exemplary embodiment, for example, the driving part 200 may apply the data voltage of about −1 V to the first pixels of the 15-grayscale W during fifteen frames. Accordingly, the first pixels are charged by a voltage corresponding to about 0 V. The driving part 200 applies the data voltage of about 0 V to the second pixels of the 0-grayscale B during fifteen frames. Accordingly, the second pixels are charged by a voltage corresponding to about +15 V. The driving part 200 applies the data voltage of about −1 V to the third pixels of the 6-grayscale G during six frames, and then applies the data voltage of about 0 V during nine frames. Accordingly, the third pixels are charged by a voltage corresponding to about +9 V.

Until an interrupt signal NT is generated based on a user's operation, for example, the driving part 200 maintains the (N+1)-th image I_{N+1} displayed on the electrophoretic display panel 100.

In an exemplary embodiment, an additional negative charge is applied to the electrophoretic particles charged to display a previous image, such that the previous image is substantially rapidly converted to the full white image. Therefore, power consumption during an image transition is substantially decreased.

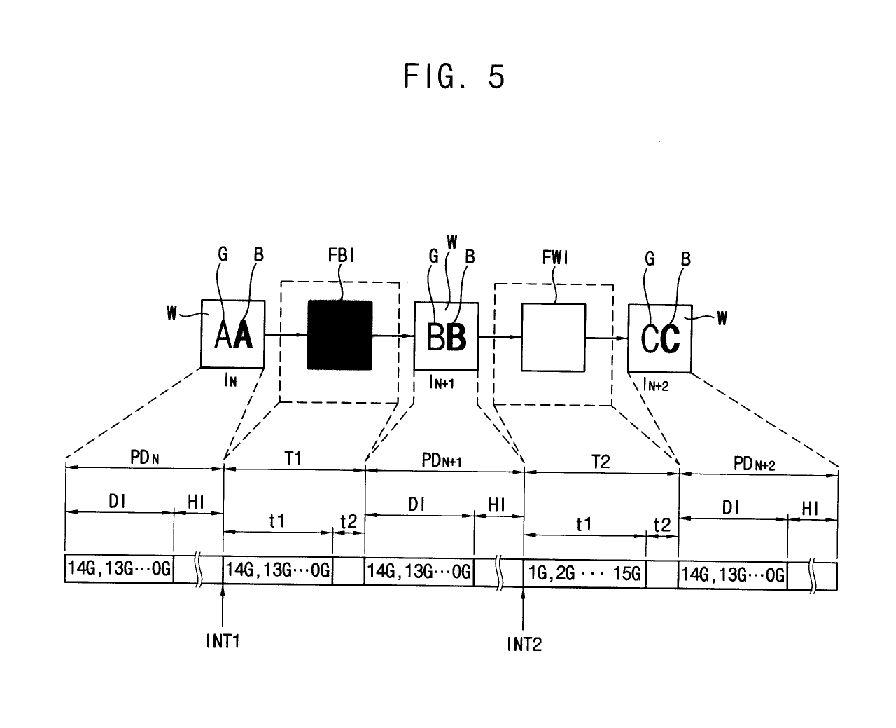

FIG. 5 is a conceptual diagram illustrating an alternative exemplary embodiment of the method of driving an electrophoretic display panel according to the present invention.

Referring to FIGS. 1 and 5, the driving interval of the electrophoretic display panel 100 includes an N-th image interval PD_{N}, a first reset interval T1, an (N+1)-th image interval PD_{N+1}, a second reset interval T2, and an (N+2)-th image interval PD_{N+2}. Here, ‘N’ is a natural number.

In an exemplary embodiment, the driving part 200 applies the positive data voltage during the display interval DI of the N-th image interval PD_{N} and displays the N-th image I_{N} including a plurality of grayscale, e.g., the 0-grayscale B, the 15-grayscale W and the 6 grayscale G, on the electrophoretic display panel 100.

When a first interrupt signal NT1 is received, the driving part 200 displays a full black image FBI on the electrophoretic display panel 100, on which the N-th image I_{N} is displayed, during a first reset interval T1. As described above referring to FIG. 3, in an exemplary embodiment of the method of displaying the full black image FBI, the positive data voltage is applied to the electrophoretic display panel 100, on which the N-th image I_{N} is displayed, and thus the full black image FBI is displayed. In an exemplary embodiment, the first reset interval T1 may be substantially the same as the number of frames required to convert a highest grayscale of the grayscales of the N-th image I_{N} to the black grayscale. In an alternative exemplary embodiment, the first reset interval T1 may include a number of frames substantially same as the sum of the number of frames, during which the highest grayscale of the grayscales of the N-th image I_{N} is converted to the black grayscale, and the number of the preset frames.

After the first reset interval T1, the driving part 200 applies the negative data voltage during the (N+1)-th image interval PD_{N+1} and displays the (N+1)-th image I_{N+1} on the electrophoretic display panel 100. As described above referring to FIG. 4, in an exemplary embodiment of the method of displaying the N+1-th image I_{N+1} from the full black image FBI, the negative data voltage is applied and thus the (N+1)-th image I_{N+1} is displayed.

Until a second interrupt signal INT2 is received, the driving part 200 maintains the (N+1)-th image I_{N+1} displayed on the electrophoretic display panel 100.

When the second interrupt signal INT2 is received, the driving part 200 displays a full white image FWI on the electrophoretic display panel 100, on which the (N+1)-th image I_{N+1} is displayed, during a second reset interval T2. As described above referring to FIG. 4, in an exemplary embodiment of the method of displaying the full white image FWI, the negative data voltage is applied and thus the full white image FWI is displayed. In an exemplary embodiment, the second reset interval T2 may include a number of frames substantially the same as the number of frames, during which a lowest grayscale of the grayscales of the (N+1)-th image I_{N+1} is converted to the white grayscale. In an alternative exemplary embodiment, the second reset interval T2 may include a number of frames substantially the same as the sum of the number of frames, during which the lowest grayscale of the grayscales of the (N+1)-th image I_{N+1} is converted to the white grayscale, and the number of the preset frames.

After the second reset interval T2, the driving part 200 applies the positive data voltage during the (N+2)-th image interval PD_{N}+₂ and displays the (N+2)-th image I_{N+2} on the electrophoretic display panel 100. As described above referring to FIG. 3, in an exemplary embodiment of the method of displaying the (N+2)-th image I_{N+2} from the full white image FWI, the positive data voltage is applied and thus the (N+2)-th image I_{N+2} is displayed.

In an exemplary embodiment, the full black image FBI is displayed during the first reset interval T1 and the full white image FWI is displayed during the second reset interval T2. In an alternative exemplary embodiment, the full white image FWI may be displayed during the first reset interval T1 and the full black image FBI may be displayed during the second reset interval T2.

In an exemplary embodiment, an additional positive charge or an additional negative charge is applied to the electrophoretic particles charged to display a previous image, such that the previous image is substantially rapidly converted to a full black image and a full white image. In an exemplary embodiment, the full reset interval is divided into the first reset interval T1, during which the full black image FBI is displayed, and the second reset interval T2, during which the full white image FWI is displayed, and images are compensated every two images of an (N+1)-th image and an (N+2)-th image, such that an image transition interval may be shorter than the image transition interval in the exemplary embodiments shown in FIGS. 1 to 4, and a flash occurring at the image transition is thereby substantially decreased.

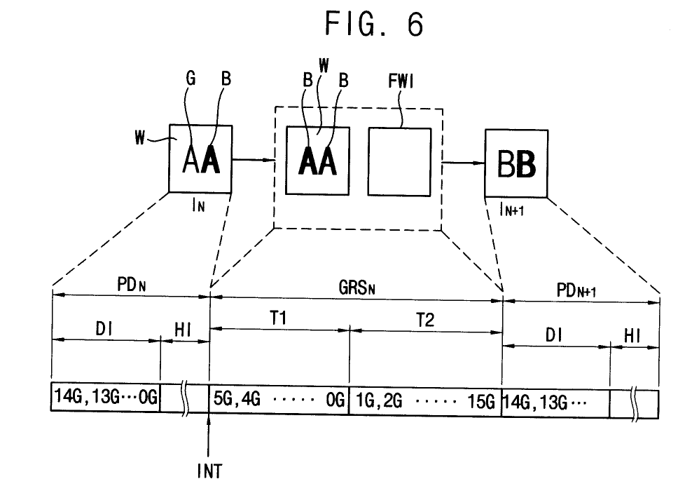

FIG. 6 is a conceptual diagram illustrating an alternative exemplary embodiment of the method of driving an electrophoretic display panel according to the present invention.

Referring to FIGS. 1 and 6, the driving interval of the electrophoretic display panel 100 includes an N-th image interval PD_{N}, an N-th grayscale reset interval GRS_{N}, and an (N+1)-th image interval PD_{N+1}. Here, ‘N’ is a natural number.

In an exemplary embodiment, the driving part 200 applies the positive data voltage to the electrophoretic display panel 100 during the display interval DI of the N-th image interval PD_{N} and displays the N-th image I_{N} including a plurality of grayscales, e.g., the 15-grayscale W, the 0-grayscale B and the 6-grayscale G. Until a first interrupt signal INT1 is received, the driving part 200 maintains the N-th image I_{N} displayed on the electrophoretic display panel 100.

When an interrupt signal NT is received, the driving part 200 compensates the difference of the charges, which is charged to the electrophoretic particles corresponding to the middle grayscale of the N-th image I_{N}, during the N-th grayscale reset interval GRS_{N}. The middle grayscale is the grayscales between the white grayscale that is the highest grayscale and the black grayscale that is the lowest grayscale.

The N-th grayscale reset interval GRS_{N} includes a first interval T1 and a second interval T2. The driving part 200 converts the middle grayscale of the N-th image I_{N} displayed on the electrophoretic display panel 100 to the black grayscale during the first interval T1, and converts the black grayscale of the N-th image I_{N} to the white grayscale during the second interval T2.

In an exemplary embodiment, during the first interval T1, the driving part 200 applies the positive data voltage to the electrophoretic display panel 100, on which the N-th image I_{N} is displayed, and converts the middle grayscale of the N-th image I_{N} to the black grayscale. In one exemplary embodiment, for example, the driving part 200 applies the data voltage of about 0 V to the first pixels having the 15-grayscale that is the white grayscale and the second pixels having the 0-grayscale that is the black grayscale, and maintains the white grayscale and the black grayscale. The driving part 200 applies the data voltage of about +1 V to the third pixels having the middle grayscale during the six frames, and the third pixels are converted to the black grayscale. Accordingly, the N-th image I_{N} displayed on the electrophoretic display panel 100 includes the white grayscale (e.g., 15-grayscale) and the black grayscale (e.g., 0-grayscale).

After the middle grayscale of the N-th image I_{N} is converted to the black grayscale during the first interval T1, the driving part 200 applies the negative data voltage to the electrophoretic display panel 100 and converts the black grayscale to the white grayscale. In one exemplary embodiment, for example, the driving part 200 applies the data voltage of about −1 V to the second pixels and the third pixels having the black grayscale (e.g., 0-grayscale) during the fifteen frames, and converts the grayscale of the second pixels and the third pixels to the white grayscale (e.g., 15-grayscale). In addition, the driving part 200 applies the data voltage of about 0 V to the first pixels having the white grayscale (e.g., 15-grayscale) and maintains the white grayscale (e.g., 15-grayscale). Accordingly, the electrophoretic display panel 100 displays the full white image FWI. The first interval T1 may include a number of frames substantially the same as the number of frames, during which the highest level of middle grayscales of the N-th image I_{N} is converted to the black grayscale, and the second interval T2 may include a number of frames substantially the same as the number of frames, during which convert black grayscale is converted to the white grayscale.

Thus, during the N-th grayscale reset interval GRS_{N}, a difference of the charges charged to the electrophoretic particles corresponding to the middle grayscale of the N-th image I_{N} is compensated.

After the N-th grayscale reset interval GRS_{N}, the driving part 200 displays the (N+1)-th image I_{N+1} on the electrophoretic display panel 100 during the (N+1)-th image interval PD_{N+1}. The (N+1)-th image interval PD_{N+1} includes a display interval DI and a maintenance interval HI. As described in FIG. 3, the driving part 200 displays the (N+1)-th image I_{N+1} from the full white image FWI. The driving part 200 applies the positive data voltage to the electrophoretic display panel 100 as the same manner of displaying the N-th image I_{N}, and thus the (N+1)-th image I_{N+1} may be displayed.

In an exemplary embodiment, the middle grayscale of the previous image is converted to the black grayscale, and then the black grayscale is converted to the white grayscale, such that the charges of electrophoretic particles that display the middle grayscale of the previous image may be compensated. In an exemplary embodiment, the grayscale reset interval is shorter than the full reset interval in the exemplary embodiments shown in FIGS. 1 to 5, such that an image transition interval may be substantially decreased, and a flash occurring at the image transition is thereby substantially decreased.

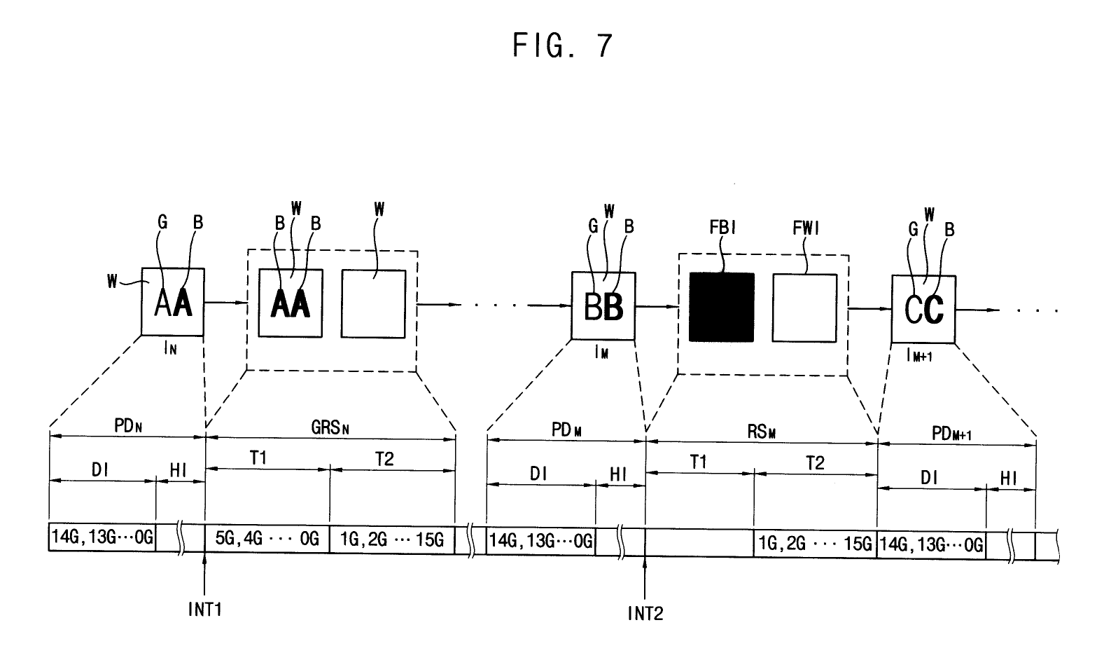

FIG. 7 is a conceptual diagram illustrating an alternative exemplary embodiment of the method of driving an electrophoretic display panel according to the present invention.

Referring to FIGS. 1 and 7, the driving interval of the electrophoretic display panel 100 includes an N-th image interval PD_{N}, an N-th grayscale reset interval GRS_{N}, an M-th image interval PD_{M}, an M-th full reset interval RS_{M}, and an (M+1)-th image interval PD_{M+1}. Here, ‘N’ and ‘M’ are natural numbers. In an exemplary embodiment, M may be greater than N.

During the N-th image interval PD_{N}, the driving part 200 displays the N-th image I_{N} on the electrophoretic display panel 100. The N-th image interval PD_{N} includes a display interval DI, during which the positive data voltage is applied to display the N-th image I_{N} on the electrophoretic display panel 100, and a maintenance interval HI, during which the N-th image I_{N} is maintained until an interrupt signal INT is generated.

When a first interrupt signal INT1 is received to display the (N+1)-th image I_{N+1}, the driving part 200 compensates differences of the charges charged to the electrophoretic particles corresponding to the middle grayscale of the N-th image I_{N} during the N-th grayscale reset interval GRS_{N}.

The N-th grayscale reset interval GRS_{N} includes the first interval T1, during which the middle grayscale of the N-th image I_{N} is converted to the black grayscale, and the second interval T2, during which the black grayscale of the N-th image I_{N} and the black grayscale converted from the middle grayscale during the first interval T1 are converted to the white grayscale.

In an exemplary embodiment, the driving part 200 applies the positive data voltage to the electrophoretic display panel 100 during the first interval T1, and converts the middle grayscale of the N-th image I_{N} to the black grayscale. The driving part 200 applies the negative data voltage to the electrophoretic display panel 100 during the second interval T2, and converts the black grayscale of the N-th image I_{N} and the black grayscale converted from the middle gray scale during the first interval T1 to the white grayscale.

After the N-th grayscale reset interval GRS_{N}, the driving part 200 displays the (N+1)-th image I_{N+1} on the electrophoretic display panel 100 during the (N+1)-th image interval PD_{N+1}. The (N+1)-th image interval PD_{N+1} includes the display interval DI and the maintenance interval HI.

In an exemplary embodiment, the driving part 200 displays a plurality of subsequent images, e.g., the (N+1)-th image to an M-th image I_{N+1} to I_{M}, which are predetermined, using the grayscale reset method described above.

Then, when a second interrupt signal INT2 to display the (M+1)-th image I_{M+1} is received, the driving part 200 compensates the differences of the charges, accumulated in the electrophoretic display panel 100 while displaying previous images, during the M-th full reset interval RS_{M}.

The M-th full reset interval RS_{M} includes a first interval T1 and a second interval T2. The driving part 200 displays a full black image FBI on the electrophoretic display panel 100 during the first interval T1, and displays a full white image FWI on the electrophoretic display panel 100 during the second interval T2. The driving part 200 applies the positive data voltage to the electrophoretic display panel 100, on which the M-th image I_{M} is displayed, during the first interval T1, and displays the full black image FBI on the electrophoretic display panel 100. The driving part 200 applies the negative data voltage to the electrophoretic display panel 100, on which the full black image FBI is displayed during the second interval T2, and converts the full black image FBI to the full white image FWI.

The method of displaying the full black image FBI on the electrophoretic display panel 100, the method of displaying the full white image FWI on the electrophoretic display panel 100 on which the full black image FBI is displayed, and the number of frames in the M-th full reset interval RS_{M} in FIG. 7 are substantially the same as the methods and the number in the exemplary embodiment shown in FIG. 3.

After the M-th full reset interval RS_{M}, the driving part 200 displays the (M+1)-th image I_{M+1} on the electrophoretic display panel 100. The driving part 200 applies the positive data voltage to the electrophoretic display panel 100 using a method substantially the same the method for displaying the N-th image, and thus displays the M+1-th image I_{M+1}.

In an exemplary embodiment, the difference of the positive charge and the negative charge accumulated in the electrophoretic display panel 100 by the grayscale reset method shown in FIG. 6, may be compensated by the full reset method.

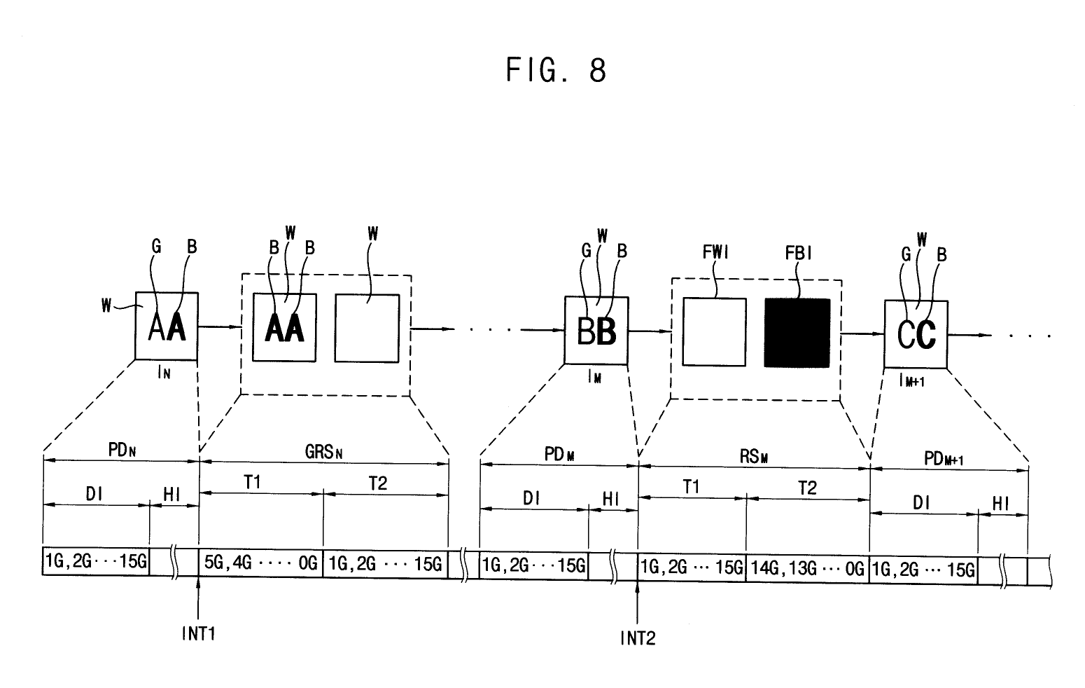

FIG. 8 is a conceptual diagram illustrating an alternative exemplary embodiment of the method of driving an electrophoretic display panel according to the present invention.

Referring to FIGS. 1 and 8, the driving interval of the electrophoretic display panel 100 includes an N-th image interval PD_{N}, an N-th grayscale reset interval GRS_{N}, an M-th image interval PD_{M}, an M-th full reset interval RS_{M}, and an (M+1)-th image interval PD_{M+1}. Here, ‘N’ and ‘M’ are natural numbers. In an exemplary embodiment, M may be greater and N.

During the N-th image interval PD_{N}, the driving part 200 applies the negative data voltage to the electrophoretic display panel 100 to display the N-th image I_{N}, and maintains the N-th image I_{N} until an interrupt signal is generated.

When a first interrupt signal INT1 is generated to display the (N+1)-th image I_{N+1}, the driving part 200 compensates a difference of the charge, charged to the electrophoretic particles corresponding to the middle grayscale of the N-th image I_{N}, during the N-th grayscale reset interval GRS_{N}.

The N-th grayscale reset interval GRS_{N} includes a first interval T1, during which the middle grayscale of the N-th image I_{N} is converted to the black grayscale, and a second interval T2, during which the black grayscale of the N-th image I_{N} and the black grayscale converted from the middle grayscale in the first interval T1 are converted to the white grayscale. The driving part 200 applies the positive data voltage to the electrophoretic display panel 100 during the first interval T1, and converts the middle grayscale of the N-th image I_{N} to the black grayscale. The driving part 200 applies the negative data voltage to the electrophoretic display panel 100 during the second interval T2, and converts the black grayscale in the first interval T1 to the white grayscale. The number of frames in the N-th grayscale reset interval GRS_{N} is substantially the same as the number in the grayscale reset interval of the exemplary embodiment shown in FIG. 6.

After the N-th grayscale reset interval GRS_{N}, the driving part 200 displays the (N+1)-th image I_{N+1} on the electrophoretic display panel 100 during the (N+1)-th image interval PD_{N+1}. The (N+1)-th image interval PD_{N+1} includes a display interval DI and a maintenance interval HI.

The driving part 200 displays a plurality of subsequent images, e.g., the (N+1)-th image to the M-th image I_{N+1} to I_{M}, which are predetermined, using the grayscale reset method describe above.

Then, when a second interrupt signal INT2 to display an (M+1)-th image I_{M+1} is received, the driving part 200 compensates a difference of the charge, accumulated in the electrophoretic display panel 100 while displaying the previous images, during the M-th full reset interval RS_{M}.

The M-th full reset interval RS_{M} includes a first interval T1 and a second interval T2. The driving part 200 displays a full white image FWI on the electrophoretic display panel 100 during the first interval T1, and displays a full black image FBI on the electrophoretic display panel 100 during the second interval T2. The driving part 200 applies the negative data voltage to the electrophoretic display panel 100, on which the M-th image I_{M} is displayed, during the first interval T1, and displays the full white image FWI on the electrophoretic display panel 100. The driving part 200 applies the positive data voltage to the electrophoretic display panel 100, on which the full white image FWI is displayed, during the second interval T2, and displays the full black image FBI.

The method of displaying the full white image FWI on the electrophoretic display panel 100, the method of displaying the full black image FBI on the electrophoretic display panel 100 on which the full white image FWI is displayed, and the number of frames in the M-th full reset interval RS_{M} in FIG. 8 are substantially the same as the methods and the number of frames in the M-th full reset interval of the exemplary embodiment shown in FIG. 4.

After the M-th full reset interval RS_{M}, the driving part 200 displays the (M+1)-th image I_{M+1} on the electrophoretic display panel 100. The driving part 200 applies the negative data voltage to the electrophoretic display panel 100, on which the full black image FBI is displayed, and displays the (M+1)-th image I_{M+1}. The driving part 200 may display the N-th image I_{N} by applying the negative data voltage to the electrophoretic display panel 100 using a method substantially the same as the method of displaying the (M+1)-th image I_{M+1}.

In an exemplary embodiment, the difference of the positive charge and the negative charge, accumulated in the electrophoretic display panel 100 by the exemplary embodiment of the grayscale reset method shown in FIG. 4, may be compensated by the full reset method.

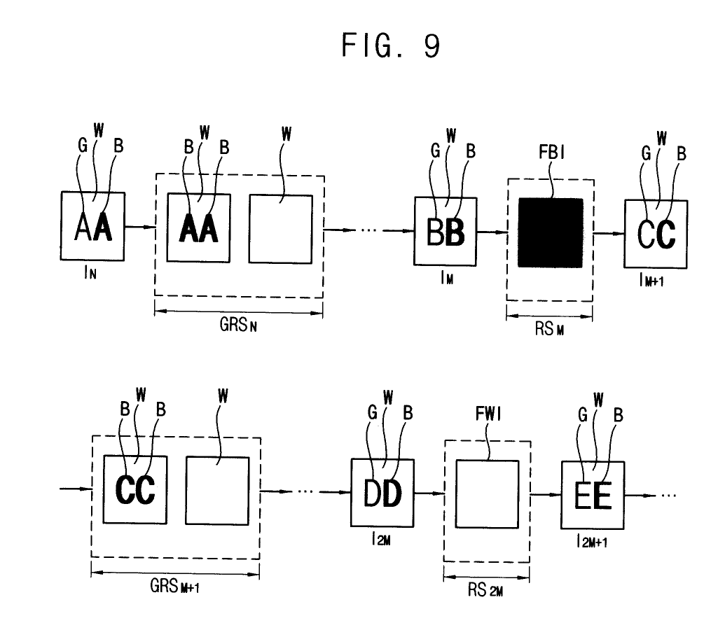

FIG. 9 is a conceptual diagram illustrating an alternative exemplary embodiment of the method of driving an electrophoretic display panel according to the present invention.

Referring to FIGS. 1 and 9, the driving interval of the electrophoretic display panel 100 includes an N-th image interval PD_{N}, an N-th grayscale reset interval GRS_{N}, an M-th image interval PD_{M}, an M-th reset interval RS_{M}, an (M+1)-th image interval PD_{M+1}, an (M+1)-th grayscale reset interval GRS_{M+1}, a 2M-th image interval PD_{2M}, a 2M-th reset interval RS_{2M}, and a (2M+1)-th image interval PD_{2M+1}. Here, ‘N’ and ‘M’ are natural numbers. In an exemplary embodiment, M may be greater than N.

The driving part 200 displays an N-th image I_{N} on the electrophoretic display panel 100 during the N-th image interval, and maintains the N-th image I_{N} until an interrupt signal is generated to convert the N-th image I_{N} to an (N+1)-th image I_{N+1}.

When the interrupt signal is received to display the (N+1)-th image I_{N+1}, the driving part 200 compensates a difference of the charges, charged to the electrophoretic particles corresponding to the middle grayscale of the N-th image I_{N}, during the N-th grayscale reset interval GRS_{N}. The driving part 200 converts the middle grayscale of the N-th image I_{N} to the black grayscale during the first interval T1 of the N-th grayscale reset interval GRS_{N}, and converts the black grayscale of the N-th image I_{N} and the black grayscale converted from the middle grayscale during the first interval T1 to the white grayscale during the second interval T2 of the N-th grayscale reset interval GRS_{N}.

After the N-th grayscale reset interval GRS_{N}, the driving part 200 displays the (N+1)-th image I_{N+1} on the electrophoretic display panel 100 during the (N+1)-th image interval PD_{N+1}. The number of frames in the N-th grayscale reset interval GRS_{N} is substantially the same as the number of frames in the grayscale reset interval of the exemplary embodiment shown in FIG. 6.

The driving part 200 displays a plurality of subsequent images e.g., the (N+1)-th image to an M-th image I_{N+1} to I_{M}, which are predetermined, using the grayscale reset method described above.

Then, when the interrupt signal to display an (M+1)-th image I_{M+1} is received, the driving part 200 compensates the difference of the negative charge, accumulated in the electrophoretic display panel 100 during displaying the previous images, in the M-th reset interval RS_{M}. In an exemplary embodiment, the driving part 200 applies the positive data voltage to the electrophoretic display panel 100, on which the M-th image I_{M} is displayed, during the M-th reset interval RS_{M}, and displays the full black image FBI on the electrophoretic display panel 100. The number of frames in the M-th reset interval RS_{M} is substantially the same as the number of frames in the M-th reset interval of the exemplary embodiment shown in FIG. 5.

Then, the driving part 200 applies the negative data voltage to the electrophoretic display panel 100, on which the full black image FBI is displayed, and displays the (M+1)-th image I_{M+1} and maintains the (M+1)-th image I_{M+1}. When the interrupt signal is received to convert the (M+1)-th image I_{M+1} to an (M+2)-th image I_{M+2}, the driving part 200 compensates a difference of the charge, charged to the electrophoretic particles corresponding to the middle grayscale of the (M+1)-th image I_{M+1}, during the (M+1)-th grayscale reset interval GRS_{M+1}. The number of frames in the (M+1)-th grayscale reset interval GRS_{M+1} is substantially the same as the number of frames in the grayscale reset interval of the exemplary embodiment shown in FIG. 6.

After the (M+1)-th grayscale reset interval GRS_{M+1}, the driving part 200 displays the (M+2)-th image I_{M+2} on the electrophoretic display panel 100 and maintains the (M+2)-th image I_{M+2}.

The driving part 200 may display Ma plurality of subsequent images, e.g., the (M+1)-th image to a 2M-th image I_{M+1} to I_{2M}, which are predetermined, using the grayscale reset method described above.

Then, when the interrupt signal to display a (2M+1)-th image I_{2M+1} is received, the driving part 200 compensates the difference of the positive charge, accumulated in the electrophoretic display panel 100, during the 2M-th reset interval RS_{2M}. In an exemplary embodiment, the driving part 200 applies the negative data voltage to the electrophoretic display panel 100, on which the 2M-th image I_{2M} is displayed, during the 2M-th reset interval RS_{2M}, and displays the full white image FWI on the electrophoretic display panel 100. The number of frames in the 2M-th reset interval RS_{2M} is substantially the same as the number of frames in the reset interval of the exemplary embodiment shown in FIG. 5.

Then, the driving part 200 applies the positive data voltage to the electrophoretic display panel 100, on which the full white image FWI is displayed, and displays the (2M+1)-th image I_{2M+1} and maintains the (2M+1)-th image I_{2M+1}.

In an exemplary embodiment, the full black image FBI is displayed during the M-th reset interval RS_{M} and the full white image FWI is displayed during the 2M-th reset interval RS_{2M}. In an alternative exemplary embodiment, the order of displaying the full black image FBI and the full white image FWI may be changed. In an exemplary embodiment, the (M+1)-th image I_{M+1} is displayed by applying the positive data voltage to the electrophoretic display panel 100, on which the full white image FWI is displayed, during the M-th reset interval RS_{M}, and the (2M+1)-th image I_{2M+1} is displayed by applying the negative data voltage to the electrophoretic display panel 100, on which the full black image FBI is displayed, during the 2M-th reset interval RS_{2M}.

In an exemplary embodiment, the difference of the positive charge and the negative charge, accumulated in the electrophoretic display panel 100 due to the exemplary embodiment of the grayscale reset method shown in FIG. 6, may be compensated by the full reset method. In an exemplary embodiment, a flash occurring at the image transition is substantially decreased, compared to the full reset method, in which the image is continuously converted to the full black image FBI and to the full white image FWI.

In an exemplary embodiment, the positive charge or the negative charge is applied to the charges, charged to the electrophoretic particles to display a previous image, such that the previous image is substantially rapidly converted to a full black image and a full white image. Therefore, power consumption during an image transition is substantially decreased, and a flash occurring at the image transition is substantially decreased.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A method of driving an electrophoretic display panel, the method comprising:
applying a first voltage having a first polarity with respect to a reference voltage to the electrophoretic display panel to display an N-th image, wherein N is a natural number;
applying the first voltage to the electrophoretic display panel on which the N-th image is displayed, to display a first full grayscale image;
applying a second voltage having a second polarity with respect to the reference voltage to the electrophoretic display panel, on which the first full grayscale image is displayed, to display a second full grayscale image, wherein the second polarity is opposite to the first polarity; and
applying the first voltage to the electrophoretic display panel, on which the second full grayscale image is displayed, to display an (N+1)-th image.

2. The method of claim 1, wherein the first full grayscale image is a full black image, and the second full grayscale image is a full white image.

3. The method of claim 2, wherein an interval, during which the N-th image is converted to the full black image, is substantially the same as an interval, during which a highest grayscale of the N-th image is converted to a black grayscale.

4. The method of claim 1, wherein the first full grayscale image is a full white image, and the second full grayscale image is a full black image.

5. The method of claim 4, wherein an interval, during which the N-th image is converted to the full white image, is substantially the same as an interval, during which a lowest grayscale of the N-th image is converted to a white grayscale.

6. A method of driving an electrophoretic display panel, the method comprising:
applying a first voltage having a first polarity with respect to a reference voltage to the electrophoretic display panel to display an N-th image, wherein N is a natural number;
applying the first voltage to the electrophoretic display panel, on which the N-th image is displayed, to display a first full grayscale image;
applying a second voltage having a second polarity with respect to the reference voltage to the electrophoretic display panel, on which display the first full grayscale image is displayed, to display an (N+1)-th image, wherein the second polarity is opposite to the first polarity; and
applying the second voltage to the electrophoretic display panel, on which the (N+1)-th image is displayed, to display a second full grayscale image.

7. The method of claim 6, wherein the first full grayscale image is a full black image, and the second full grayscale image is a full white image.

8. The method of claim 7, wherein an interval, during which N-th image is converted to the full black image, is substantially the same as an interval, during which a highest grayscale of the N-th image is converted to a black grayscale.

9. The method of claim 6, wherein the first full grayscale image is a full white image, and the second full grayscale image is a full black image.

10. The method of claim 9, wherein an interval, during which the N-th image is converted to the full white image, is substantially the same as an interval, during which a lowest grayscale of the N-th image is converted to a white grayscale.

11. A method of driving an electrophoretic display panel, the method comprising:
displaying an N-th image on the electrophoretic display panel, wherein N is a natural number;
converting a middle grayscale of the N-th image to a black grayscale;
converting each of a black grayscale of the N-th image and the black grayscale converted from the middle grayscale of the N-th image to a white grayscale; and
displaying an (N+1)-th image on the electrophoretic display panel having a full white grayscale.

12. The method of claim 11, further comprising:
applying a first voltage having a first polarity with respect to a reference voltage to the electrophoretic display panel, on which an M-th image is displayed, to display a first full grayscale image, wherein M is a natural number;
applying an second voltage having a second polarity with respect to the reference voltage to the electrophoretic display panel, on which the first full grayscale image is displayed, to display a second full grayscale image, wherein the second polarity is opposite to the first polarity; and
applying the first voltage to the electrophoretic display panel, on which the second full grayscale image is displayed, to display an (M+1)-th image.

13. The method of claim 12, wherein the first full grayscale image is a full black image, and the second full grayscale image is a full white image.

14. The method of claim 13, wherein an interval, during which the M-th image is converted to the full black image, is substantially the same as an interval, during which a highest grayscale of the M-th image is converted to a black grayscale.

15. The method of claim 12, wherein the first full grayscale image is a full white image, and the second full grayscale image is a full black image.

16. The method of claim 15, wherein an interval during, which the M-th image is converted to the full white image, is substantially the same as an interval, during which a lowest grayscale of the M-th image is converted to a white grayscale.

17. The method of claim 11, further comprising:
applying a first voltage having a first polarity with respect to a reference voltage to the electrophoretic display panel, on which an M-th image is displayed, to display a first full grayscale image, wherein M is a natural number;
applying a second voltage having a second polarity with respect to the reference voltage to the electrophoretic display panel, on which the first full grayscale image is displayed, to display an (M+1)-th image, wherein the second polarity is opposite to the first polarity;
applying the second voltage to the electrophoretic display panel, on which a 2M-th image is displayed, to display a second full grayscale image; and
applying the first voltage to the electrophoretic display panel, on which the second full grayscale image is displayed, to display a (2M+1)-th image.

18. The method of claim 17, wherein the first full grayscale image is a full black image, and the second full grayscale image is a full white image.

19. The method of claim 17, wherein the first full grayscale image is a full white image, and the second full grayscale image is a full black image.
